(19) United States
(12) Patent Application Publication
(10) Pub. No.: US 2016/0322633 A1
(43) Pub. Date: Nov. 3, 2016

(54) COBALT OXIDE COMPOSITION FOR LITHIUM SECONDARY BATTERY, LITHIUM COBALT OXIDE COMPOSITION FOR LITHIUM SECONDARY BATTERY FORMED FROM THE COBALT OXIDE COMPOSITION, METHOD OF MANUFACTURING THE COBALT OXIDE COMPOSITION, AND LITHIUM SECONDARY BATTERY INCLUDING POSITIVE ELECTRODE INCLUDING THE LITHIUM COBALT OXIDE COMPOSITION

(71) Applicant: SAMSUNG SDI CO., LTD., Yongin-si (KR)

(72) Inventors: Jihyun KIM, Yongin-si (KR); Seonyoung KWON, Yongin-si (KR); Junseok PARK, Yongin-si (KR); Dohyung PARK, Yongin-si (KR)

(21) Appl. No.: 15/139,814

(22) Filed: Apr. 27, 2016

(30) Foreign Application Priority Data
Apr. 28, 2015 (KR) 10-2015-0059634

(51) Int. Cl. H01M 4/485; C01G 51/00; H01M 4/131; H01M 10/0525; H01M 4/04

(52) U.S. Cl. CPC H01M 4/485; H01M 10/0525; H01M 4/0497; H01M 4/0471; H01M 4/131; C01G 51/42; H01M 2004/028

(57) ABSTRACT

A cobalt oxide for a lithium secondary battery, a lithium cobalt oxide, an associated method, and a lithium secondary battery, wherein the cobalt oxide composition includes particles having a particle strength of about 25 MPa to about 50 MPa, has a particle diameter D10 of about 14 μm to about 18 μm, and has a particle diameter difference between a particle diameter D90 and the particle diameter D10 of less than about 15 μm.

### CROSS-REFERENCE TO RELATED APPLICATION

Korean Patent Application No. 10-2015-0059634, filed on Apr. 28, 2015, in the Korean Intellectual Property Office, and entitled: “Cobalt Oxide for Lithium Secondary Battery, Lithium Cobalt Oxide for Lithium Secondary Battery Formed from the Cobalt Oxide, Method of Manufacturing the Cobalt Oxide, and Lithium Secondary Battery Including Positive Electrode Including the Lithium Cobalt Oxide,” is incorporated by reference herein in its entirety.

### BACKGROUND

1. Field

Embodiments relate to a cobalt oxide composition for lithium secondary battery, lithium cobalt oxide composition for lithium secondary battery formed from the cobalt oxide composition, method of manufacturing the cobalt oxide composition, and lithium secondary battery including positive electrode including the lithium cobalt oxide composition.

2. Description of the Related Art

Lithium secondary batteries, due to high voltage capacity and high energy density thereof, may be used in a variety of fields. For example, lithium secondary batteries for use in electric vehicles (e.g., HEV and PHEV) may have excellent capacities for charging or discharging large amounts of electric power, and may have the capability to operate at a high temperature.

### SUMMARY

Embodiments are directed to a cobalt oxide composition for lithium secondary battery, lithium cobalt oxide composition for lithium secondary battery formed from the cobalt oxide composition, method of manufacturing the cobalt oxide composition, and lithium secondary battery including positive electrode including the lithium cobalt oxide composition.

The embodiments may be realized by providing a cobalt oxide for a lithium secondary battery, wherein the cobalt oxide composition includes particles having a particle strength of about 25 MPa to about 50 MPa, has a particle diameter D10 of about 14 μm to about 18 μm, and has a particle diameter difference between a particle diameter D90 and the particle diameter D10 of less than about 15 μm.

The cobalt oxide may have an average particle diameter D50 of about 18.4 μm to about 19 μm.

The cobalt oxide may have a particle diameter D90 of about 26 μm to about 28 μm.

The particle diameter difference between the particle diameter D90 and the average diameter D10 may be about 10 μm to about 12 μm. The embodiments may be realized by providing a lithium cobalt oxide for a lithium secondary battery, wherein the lithium cobalt oxide has a mixture density in a range of about 3.8 g/cc to about 3.97 g/cc and the lithium cobalt oxide composition includes lithium cobalt oxide represented by Formula 1:

LiₐCo_{b}O_{c} [Formula 1]

wherein, in Formula 1, a, b, and c satisfy the following relations: 0.9≦a≦1.1, 0.98≦b≦1.00, and 1.9≦c≦2.1.

The lithium cobalt oxide composition includes lithium cobalt oxide that further includes at least one of magnesium (Mg), calcium (Ca), strontium (Sr), titanium (Ti), zirconium (Zr), boron (B), aluminum (Al), and fluorine (F).

An average particle diameter D50 of the lithium cobalt oxide may be about 5 μm to about 20 μm.

The embodiments may be realized by providing a method of preparing the lithium cobalt oxide according to an embodiment, the method including providing a cobalt oxide composition; and heat treating a mixture of the cobalt oxide composition and a lithium precursor at a temperature in a range of about 900° C. to about 1,100° C., wherein the cobalt oxide composition includes particles having a particle strength of about 25 MPa to about 50 MPa, has a particle diameter D10 of about 14 μm to about 18 μm, and has a particle diameter difference between a particle diameter D90 and the average particle diameter D10 of less than about 15 μm.

Providing the cobalt oxide may include preparing cobalt hydroxide by co-precipitating a mixture of a cobalt precursor, a precipitator, and a chelating agent; drying the cobalt hydroxide; and heat treating the dried cobalt hydroxide at a temperature of about 800° C. to about 850° C.

Heat treating the dried cobalt hydroxide may be performed under an oxidizing gas atmosphere.

Heat treating the mixture may be performed under an oxidizing gas atmosphere.

The embodiments may be realized by providing a lithium secondary battery including a positive electrode, the positive electrode including the lithium cobalt oxide composition according to an embodiment.

### BRIEF DESCRIPTION OF THE DRAWINGS

Features will be apparent to those of skill in the art by describing in detail exemplary embodiments with reference to the attached drawings in which:

FIG. 1 illustrates a schematic view of a lithium secondary battery according to an exemplary embodiment;

FIGS. 2A and 2B illustrate scanning electron microscope (SEM) images showing cobalt oxide prepared in Example 1 at different magnification levels;

FIGS. 3A and 3B illustrate SEM images showing cobalt oxide prepared in Comparative Example 1 at different magnification levels;

FIGS. 4A and 4B illustrate optical microscope images showing cobalt oxide prepared in Example 1, the images being obtained after performing the Mixer Test;

FIGS. 5A and 5B illustrate optical microscope images showing cobalt oxide prepared in Comparative Example 1, the images being obtained after performing the Mixer Test;

FIG. 6 illustrates a graph showing the results of a particle diameter distribution analysis on cobalt oxides prepared in Example 1 and Comparative Example 1;

FIGS. 7A and 7B illustrate SEM images showing lithium cobalt oxide prepared in Example 1;

FIGS. 8A and 8B illustrate SEM images showing lithium cobalt oxide prepared in Comparative Example 1;

FIG. 9 illustrates a graph showing voltage changes according to capacity of a coin-half cell manufactured in Manufacture Example 1; and

FIG. 10 illustrates a graph showing voltage changes according to capacity of a coin-half cell manufactured in Comparative Manufacture Example 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, a lithium cobalt composite oxide or lithium cobalt oxide and a precursor thereof, a method of preparing the lithium cobalt oxide and the precursor thereof, and a lithium secondary battery including a positive electrode that includes the lithium cobalt oxide will be described in detail according to exemplary embodiments.

The embodiments may provide cobalt oxide (Co₃O₄), e.g., a cobalt (II, III) oxide material, particle, or composition, for a lithium secondary battery. For example, the cobalt oxide composition may include or consist of cobalt oxide particles. Particles of cobalt oxide in the cobalt oxide composition may have a particle strength of about 25 MPa to about 50 MPa. The cobalt oxide composition may have a particle diameter D10 of, e.g., about 14 μm to about 18 μm. The cobalt oxide composition may have a particle diameter D90. For example, the particle diameter D10 refers to a particle diameter at which a cumulative volume of the cobalt oxide is 10%, and the particle diameter D90 refers to a particle diameter at which the cumulative volume of the cobalt oxide is 90%. In an implementation, a particle diameter difference between the particle diameter D90 and the particle diameter D10 may be less than about 15 μm.

The terms “D50” used herein refer to an average particle diameter corresponding to 50 vol % in a cumulative particle size distribution curve based on a total volume of 100% of particles from the smallest particle diameter. The terms “D90”, and “D10” used herein respectively refer to a particle diameter corresponding to 90 vol %, and 10 vol % in a cumulative particle size distribution curve based on a total volume of 100% of particles from the smallest particle diameter. For example, the cobalt oxide composition may include cobalt oxide particles of differing sizes.

Lithium cobalt oxide may be used as a positive electrode active material for a lithium secondary battery. However, in accordance with a demand upon a lithium secondary battery prepared by solid solution hardening, methods of increasing a capacity of the lithium cobalt oxide have been considered. In this regard, a density and a sphericity of the lithium cobalt oxide are have been considered.

For example, the lithium cobalt oxide may be prepared according to a solid state reaction. In this case, a particle shape may not be easily controlled.

According to an embodiment, a cobalt oxide or cobalt oxide composition may be prepared according to a co-precipitation method. The cobalt oxide composition may have a great particle strength and good particle diameter distribution characteristics. Thus, lithium cobalt oxide having good sphericity and mixture density characteristics may be prepared by using the cobalt oxide composition. The cobalt oxide composition may exhibit a great particle strength, the sphericity of the cobalt oxide may be maintained without a rupture upon mixing with a lithium precursor, such as lithium carbonate, and the lithium cobalt oxide prepared by using the cobalt oxide may accordingly have not only improved sphericity and mixture density, but also improved electrochemical properties.

The cobalt oxide composition may have an average particle diameter D50 of, e.g., about 18.4 μm to about 19 μm. The cobalt oxide composition may have a particle diameter D90 of, e.g., about 26 μm to about 28 μm. In an implementation, a particle diameter difference between the particle diameter D90 and the particle diameter D10 (i.e., D90-D10) may be less than 15 μm, e.g., about 10 μm to about 12 μm. When the cobalt oxide composition has the particle diameter difference within the range above, the cobalt oxide composition may have a uniform and narrow particle diameter distribution.

Another embodiment may provide lithium cobalt oxide, e.g., a lithium cobalt oxide material, particle, or composition, for a lithium secondary battery. For example, the lithium cobalt oxide composition may include or consist of lithium cobalt oxide particles. In an implementation, the lithium cobalt oxide composition may have a mixture density of about 3.8 g/cc to about 3.97 g/cc, for example, 3.9 g/cc to 3.95 g/cc. In an implementation, the lithium cobalt oxide composition may include lithium cobalt oxide represented by Formula 1 below.

LiₐCo_{b}O_{c} [Formula 1]

In Formula 1, 0.9≦a≦1.1, 0.98≦b≦1.00, and 1.9≦c≦2.1.

The lithium cobalt oxide composition may have a large mixture density and a good sphericity. In an implementation, spherical particles of the lithium cobalt oxide composition may help minimize a specific surface area thereof. Thus, the lithium cobalt oxide composition may help provide chemical stability for a positive electrode material under conditions of charging and discharging at a high temperature. For example, a lithium secondary battery including the lithium cobalt oxide composition may have improved capacity and high efficiency characteristics.

Maintaining the mixture density of the lithium cobalt oxide composition within the range above may help ensure that a lithium secondary battery including a positive electrode that includes the lithium cobalt oxide exhibits good capacity and high efficiency characteristics.

The lithium cobalt oxide of Formula 1 may include, e.g., LiCoO₂.

In an implementation, the lithium cobalt oxide may have an average particle diameter D50 of, e.g., about 5 μm to about 20 μm. When the average particle diameter D50 of the lithium cobalt oxide composition is within the range above, a lithium secondary battery including a positive electrode that includes the lithium cobalt oxide composition may have good capacity and high efficiency characteristics.

The lithium cobalt oxide composition may further include at least one element of magnesium (Mg), calcium (Ca), strontium (Sr), titanium (Ti), zirconium (Zr), boron (B), aluminum (Al), and fluorine (F). For example, the lithium cobalt oxide may further include one of the above-described elements, in addition to lithium, cobalt, and oxygen. Accordingly, a lithium secondary battery including a positive electrode that includes the lithium cobalt oxide composition may have further improved electrochemical characteristics.

Hereinafter, a method of preparing the lithium cobalt oxide composition for the lithium secondary battery will be described in detail.

The lithium cobalt oxide composition may be synthesized according to a co-precipitation method.

First, a mixture of a cobalt oxide (Co₃O₄) composition and a lithium precursor may be subjected to a heat treatment at a temperature of about 900° C. to about 1,100° C., e.g., about 1,000° C. to about 1,100° C. The cobalt oxide composition may include the cobalt oxide composition according to an embodiment, e.g., may have a particle strength of about 25 MPa to about 50 MPa, a particle diameter D10 of about 14 μm to about 18 μm, and a particle diameter difference between the particle diameter D90 and the particle diameter D10 of less than about 15 μm.

Maintaining the temperature at which the heat treatment is performed at about 900° C. to 1,100° C. may help ensure that sphericity and mixture density of the lithium cobalt oxide composition are not degraded.

In an implementation, the lithium precursor may include, e.g., lithium hydroxide, lithium fluoride, lithium carbonate, or a mixture thereof. Here, an amount of such a lithium precursor may be adjusted in a stoichiometric manner, so as to obtain the lithium cobalt oxide of Formula 1. In an implementation, the amount of the lithium precursor may be about 1.0 mole to about 1.1 moles, based on 1 mole of cobalt oxide.

The heat treatment may be performed under an oxidizing gas atmosphere using oxidizing gas, e.g., oxygen or air. For example, the oxidizing gas may include oxygen or air in an amount of about 10 vol % to about 20 vol % and an inert gas in an amount of about 80 vol % to about 90 vol %.

The cobalt oxide composition according to an exemplary embodiment may be obtained as follows.

First, a mixture of a cobalt precursor, a precipitant, a chelating agent, and a solvent may be prepared and subjected to a co-precipitation reaction to produce precipitates. Then, the precipitates may be dried and heat treated at a temperature of about 800° C. to about 850° C., thereby obtaining a cobalt oxide composition having desired particle strength and particle diameter distribution characteristics. In an implementation, the heat treatment may be performed under an oxidizing gas atmosphere using oxidizing gas, e.g., oxygen or air. For example, the oxidizing gas may include oxygen or air in an amount of about 10 vol % to about 20 vol % and an inert gas in an amount of about 80 vol % to about 90 vol %.

The mixture may be controlled to have a pH of about 9 to about 12.

Maintaining the temperature at which the heat treatment is performed at about 800° C. to about 850° C. may help ensure that the cobalt oxide is formed in a spherical shape and/or may help prevent degradation of the particle strength and particle diameter distribution characteristics thereof.

The precipitant may use, e.g., a sodium hydroxide solution or the like as a pH regulator.

The chelating agent may include, e.g., ammonia, ammonia sulfate, or the like.

The mixture may be purged with nitrogen, so as to obtain cobalt hydroxide, or precipitates obtained without being purged with nitrogen may be washed, filtered, and dried, so as to obtain cobalt hydroxide.

The co-precipitates may be dried at a temperature of about 100° C. to about 150° C.

When the mixture has a pH range from about 9 to about 12, cobalt oxide having a desired particle state may be obtained.

The cobalt precursor may include, e.g., cobalt sulfate, cobalt nitrate, cobalt chloride, or the like. Here, an amount of the cobalt precursor may be adjusted in a stoichiometric manner, so as to obtain the lithium cobalt oxide of Formula 1.

The solvent may include, e.g., water or the like. For example, an amount of the solvent may be about 100 parts by weight to about 3,000 parts by weight, based on 100 parts by weight of the cobalt precursor. When the amount of the solvent is within the range above, the mixture of which each component may be uniformly mixed may be obtained.

As described above, the particle strength and the particle diameter distribution of the cobalt oxide composition may be controlled so that lithium cobalt oxide composition obtained by using the cobalt oxide composition may maintain a spherical particle shape and have a good mixture density. When the lithium cobalt oxide composition is used in manufacturing a positive electrode, a lithium secondary battery having improved capacity and high efficiency characteristics may be prepared.

Hereinafter, a method of preparing a lithium secondary battery using the lithium cobalt oxide composition as a positive electrode active material for a lithium secondary battery will be described in detail. For example, a method of preparing lithium secondary battery that includes a positive electrode, a negative electrode, a non-aqueous electrolyte containing a lithium salt, and a separator will be described in detail.

A positive electrode and a negative electrode may each be prepared by coating a current collector with a composition for forming a positive electrode active material layer and a composition for forming a negative electrode active material layer.

The composition for forming a positive electrode active material layer may be prepared by mixing a positive electrode active material, a conducting agent, a binder, and a solvent. The positive electrode active material may include the lithium cobalt oxide composition described above.

The binder may facilitate binding of an active material and a current collector and binding of active material particles. In an implementation, an amount of the binder to be added to the composition may be about 1 part by weight to about 50 parts by weight, based on 100 parts by weight (or a total weight) of the positive electrode active material. Examples of the binder may include polyvinylidene fluoride (PVDF), polyvinyl alcohols, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene butadiene rubber, fluoro rubber, and various copolymers. In an implementation, an amount of the binder may be about 2 parts by weight to about 5 parts by weight, based on 100 parts by weight (total weight) of the positive electrode active material. When the amount of the binder is within the ranges above, the binder may have stronger attachment to the current collector.

A suitable material that has conductivity and does not induce a chemical change in batteries may be used as the conducting agent. Examples of the conducting agent may include graphite, such as natural graphite or artificial graphite; carbonaceous materials, such as carbon black, acetylene black, ketjen black, channel black, furnace black, lamp black, or summer black; conducting fibers, such as carbon fibers or metal fibers; metal powders, such as aluminum powders, or nickel powders; carbon fluoride powders; conducting whiskers, such as zinc oxide or potassium titanate; conducting metal oxide, such as titanium oxide; and a conducting material, such as a polyphenylene derivative.

An amount of the conducting agent may be about 2 parts by weight to about 5 parts by weight, based on 100 parts by weight (or the total weight) of the positive electrode active material. When the amount of the conducting agent is within the range above, a finally obtained electrode may have high conductivity,

An example of the solvent may include N-methylpyrrolidone.

An amount of the solvent may be about 1 part by weight to about 80 parts by weight, based on 500 parts by weight (or the total weight) of the positive electrode active material. When the amount of the solvent is within the range above, the positive electrode active material layer may be easily formed.

A positive electrode current collector may have a thickness of about 3 μm to about 500 μm, and a suitable material that has high conductivity and does not induce a chemical change in batteries may be used as the positive electrode current collector. Examples of the positive electrode current collector may include stainless steel, aluminum, nickel, titanium, and heat-treated carbon. In an implementation, the positive electrode current collector may be aluminum or a stainless steel, each surface-treated with carbon, nickel, titanium, or silver. The positive electrode current collector may have a corrugated surface to facilitate stronger attachment of the positive electrode active material to the positive electrode current collector. The positive electrode current collector may be prepared in various forms, such as a film, a sheet, a foil, a net, a porous product, a foam, or a non-woven fabric.

Separately, the composition for forming a negative electrode active material layer may be prepared by mixing a negative electrode active material, a binder, a conducting agent, and a solvent.

The negative electrode active material may be a material capable of intercalating/deintercalating lithium ions. Examples of the negative electrode active material may include carbonaceous materials, such as graphite or carbon, lithium metals and alloys thereof, or silicon oxides. In an implementation, the negative electrode active material may include silicon oxide.

An amount of the binder may be about 1 part by weight to about 50 parts by weight, based on 100 parts by weight (or the total weight) of the negative electrode active material. Examples of the binder may include those described above with respect to the positive electrode.

An amount of the conducting agent may be about 1 part by weight to about 5 parts by weight, based on 100 parts by weight (orthe total weight) of the negative electrode active material. When the amount of the conducting agent is within the range above, a finally obtained electrode may have high conductivity.

An amount of the solvent may be about 1 part by weight to about 10 parts by weight, based on 100 parts by weight (or the total weight) of the negative electrode active material. When the amount of the solvent is within the range above, the negative electrode active material layer may be easily formed.

Examples of the conducting agent and the solvent may include those described above with respect to the positive electrode.

A negative electrode current collector may have a thickness in a range of about 3 μm to about 500 μm. A suitable material that has high conductivity and does not induce a chemical change in batteries may be used as the negativeelectrode current collector. Examples of materials for the negative electrode current collector may include copper, stainless steel, aluminum, nickel, titanium, and heat-treated carbon. In an implementation, the negative electrode current collector may be copper or a stainless steel, each surface-treated with carbon, nickel, titanium, or silver. In an implementation, the negative electrode current collector may be an aluminum-cadmium alloy. In an implementation, as described in connection with the positive electrode current collector, the negative electrode current collector may have a corrugated surface to facilitate stronger attachment of the negative electrode active material to the negative electrode current collector. The negative electrode current collector may be prepared in various forms, such as a film, a sheet, a foil, a net, a porous product, a foam, or a non-woven fabric.

The separator is placed between the positive electrode and the negative electrode.

The separator may have a pore diameter of about 0.01 μm to about 10 μm, and a thickness of about 5 μm to about 300 μm. For example, the separator may be a sheet or a non-woven fabric, each of which is formed of an olefin-based polymer, such as polypropylene or polyethylene; or glass fiber. When a solid electrolyte, such as a polymer, is used as an electrolyte, the solid electrolyte may also act as the separator.

The non-aqueous electrolyte containing a lithium salt may include a non-aqueous electrolyte and lithium salt. The non-aqueous electrolyte may be a non-aqueous electrolytic solvent, an organic solid electrolyte, or an inorganic solid electrolyte.

An example of the non-aqueous electrolytic solvent may include an aprotic organic solvent, such as N-methyl-2-pyrrolidinone, propylene carbonate, ethylene carbonate, butylene carbonate, dimethyl carbonate, diethyl carbonate, gamma-butyrolactone, 1,2-dimethoxy ethane, 2-methyl tetrahydrofuran, dimethylsulfoxide, 1,3-dioxolane, N,N-dimethyl formamide, dioxolane, acetonitrile, nitromethane, methyl formate, methyl acetate, triester phosphate, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, or ethyl propionate.

Examples of the organic solid electrolyte may include polyethylene derivatives, polyethylene oxide derivatives, polypropylene oxide derivatives, phosphate ester polymers, polyvinyl alcohol, and polyvinylidene fluoride.

Examples of the inorganic solid electrolyte may include Li₃N, LiI, Li₅NI₂, Li₃N—LiI—LiOH, Li₂SiS₃, Li₄SiO₄,Li₄SiO₄—LiI—LiOH, or Li₃PO₄—Li₂S—SiS₂.

The lithium salt may be a material that is easily dissolved in the non-aqueous electrolyte. Examples of the lithium salt may include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, (CF₃SO₂)₂NLi, lithium chloroborate, lower aliphatic carboxylic acid lithium, and lithium tetraphenyl borate.

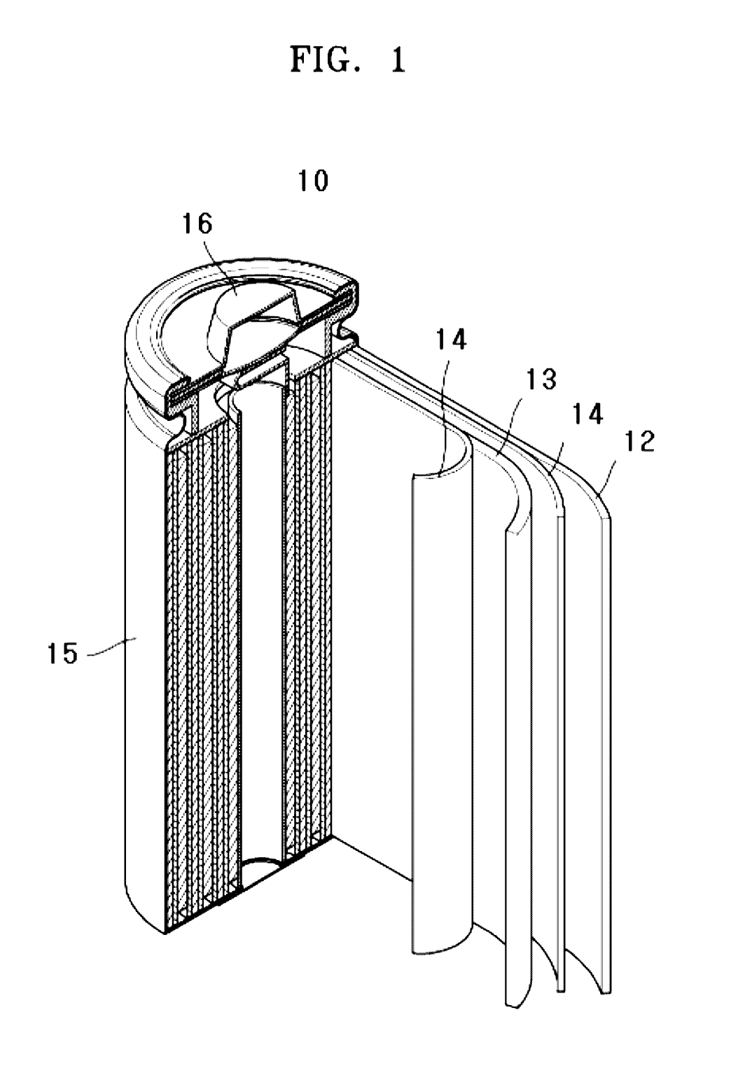

FIG. 1 illustrates a schematic view of a lithium secondary battery 10 according to an exemplary embodiment.

Referring to FIG. 1, the lithium secondary battery 30 may include a positive electrode 13, a negative electrode 12, a separator 14 between the positive electrode 23 and the negative electrode 22, an electrolyte impregnated with the positive electrode 13, the negative electrode 12, and the separator 14, a battery case 15, and a cap assembly 16 for sealing the battery case 15. In an implementation, the lithium secondary battery 10 may be formed by sequentially stacking the positive electrode 13, the negative electrode 12, and the separator 14, and then, by spiral-winding the stacked structure to be housed in the battery case 15. The battery case 15 may then be sealed with the cap assembly 16, thereby completing the manufacturing of the lithium secondary battery 10.

The following Examples and Comparative Examples are provided in order to highlight characteristics of one or more embodiments, but it will be understood that the Examples and Comparative Examples are not to be construed as limiting the scope of the embodiments. Further, it will be understood that the embodiments are not limited to the particular details described in the Examples and Comparative Examples.

### EXAMPLE 1

600 ml of a 2 M cobalt sulfate solution, 300 ml of a 8 M NaOH solution (precipitant), and 90 ml of a NH₄OH solution (chelating agent) were respectively prepared, and then, simultaneously added to a reactor. A pH of the reaction mixture was adjusted to about 10, and then the resultant was stirred at 40° C. thereby forming precipitates.

The resultant precipitates were filtered, washed, and dried overnight at a temperature of 120° C., thereby obtaining cobalt hydroxide (Co(OH)₂).

The cobalt hydroxide Co(OH)₂ was subjected to a first heat treatment at a temperature of about 800° C. for 6 hours under an oxygen-containing atmosphere, thereby obtaining cobalt oxide (CO₃O₄).

The cobalt oxide Co₃O₄ obtained by the first heat treatment and lithium carbonate were dry-blended for about 0.5 hours in a mixer, such that an atomic ratio of lithium to cobalt was set to about 1. The mixture was then subjected a second heat treatment at a temperature of about 1,100° C. and a flow rate of 20 liters per minute (LPM) oxygen for 10 hours under an oxygen-containing atmosphere, thereby obtaining lithium cobalt oxide (LiCoO₂).

### EXAMPLE 2

Cobalt oxide (Co₃O₄) and lithium cobalt oxide LiCoO₂ were prepared in the same manner as in Example 1, except that the temperature at which the first heat treatment was performed was changed to 850° C.

### COMPARATIVE EXAMPLE 1

Cobalt oxide (Co₃O₄) and lithium cobalt oxide LiCoO₂ were prepared in the same manner as in Example 1, except that the temperature at which the first heat treatment was performed was changed to 750° C.

### COMPARATIVE EXAMPLE 2

Cobalt oxide (Co₃O₄) and lithium cobalt oxide LiCoO₂ were prepared in the same manner as in Example 1, except that the temperature at which the first heat treatment was performed was changed to 900° C.

### MANUFACTURE EXAMPLE 1

The lithium cobalt composite oxide of Example 1, i.e., the positive electrode active material prepared in Example 1, was used to manufacture a coin cell as follows.

96 g of the positive electrode active material of Example 1, 2 g of polyvinylidenefluoride, 137 g of a solvent, N-methylpyrrolidone, and 2 g of a conducting agent, carbon black, were completely mixed, and bubbles formed in the mixture were removed by using a blender, thereby manufacturing a slurry for forming a positive electrode active material layer.

The slurry was applied to an aluminum thin plate by using a doctor blade to prepare a thin plate coated with the slurry. The thin plate was dried at a temperature of 135° C. for at least 3 hours, and then, rolled and vacuum-dried, thereby manufacturing a positive electrode.

The positive electrode and lithium metal, which was used as a counter electrode, were used together to manufacture a 2032 sized coin cell. A separator (having a thickness of about 16 μm), which was formed of porous polyethylene (PE) film, was positioned between the positive electrode and the lithium metal, and then, an electrolytic solution was added thereto, thereby manufacturing the 2032 sized coin cell.

The electrolytic solution was a solution in which LiPF₆ was dissolved to form a 1.1 M solution in a solvent in which ethylene carbonate (EC) and ethylmethyl carbonate (EMC) were mixed in a volume ratio of 3:5.

### MANUFACTURE EXAMPLE 2

A coin cell was prepared in the same manner as in Manufacture Example 1, except that the positive electrode active material of Example 2 was used instead of the positive electrode active material of Example 1.

### COMPARATIVE MANUFACTURE EXAMPLES 1 and 2

Coin cell were prepared in the same manner as in Manufacture Example 1, except that the positive electrode active materials of Comparative Manufacture Examples 1 and 2 were each used instead of the positive electrode active material of Example 1.

### EVALUTION EXAMPLE 1

### Measurement of a Particle Strength of Cobalt Oxide

The cobalt oxides of Example 1 and Comparative Examples 1 and 2 were subjected to measure of particle strength thereof.

The particle strength, e.g., compressive particle strength, of the cobalt oxides of Example 1 and Comparative Examples 1 and 2 was measured by using a device (MCT-W500-E available from Shimadzu Corporation). That is, the particles of the cobalt oxides were placed as a sample on a glass of an optical microscope, and a pressure, e.g., compressive pressure, was applied thereto by using a probe, so as to measure a particle strength thereof.

Here, an average value of at least 5 cobalt oxide particles was defined as a particle strength of the cobalt oxide, and the measurement results are shown in Table 1 below.

TABLE 1

| Division | Particle strength (MPa) |
|---|---|
| Example 1 | 30.166 |
| Example 2 | 31.47 |
| Example 3 | 29.15 |
| Example 4 | 31.03 |
| Example 5 | 32.51 |
| Comparative Example 1 | 11.366 |
| Comparative Example 2 | 13.237 |

Referring to Table 1, the cobalt oxide of Example 1 exhibited enhanced particle strength, compared with particle strengths of the cobalt oxides of Comparative Examples 1 and 2.

### EVALUATION EXAMPLE 2

### Scanning Electron Microscopy (SEM)

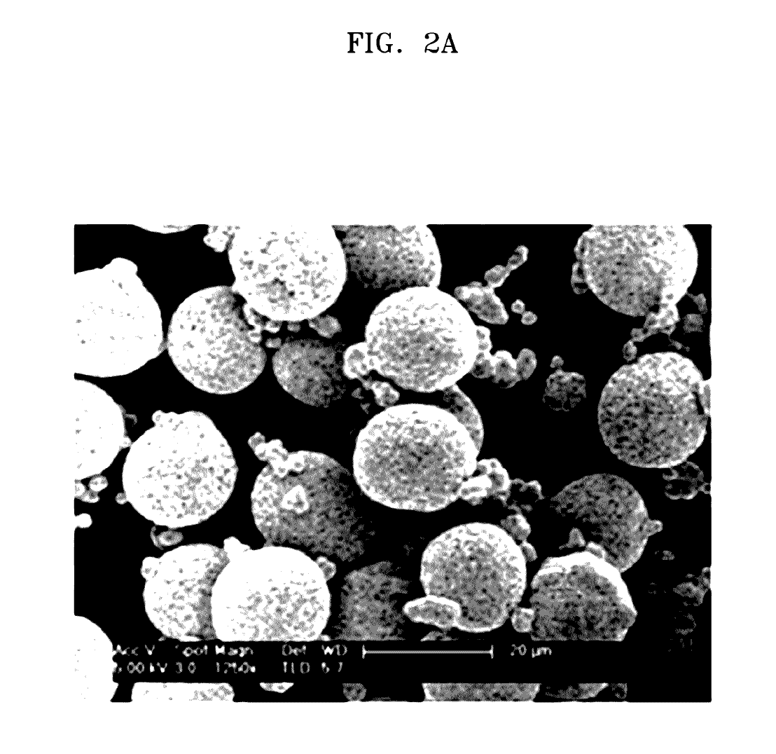

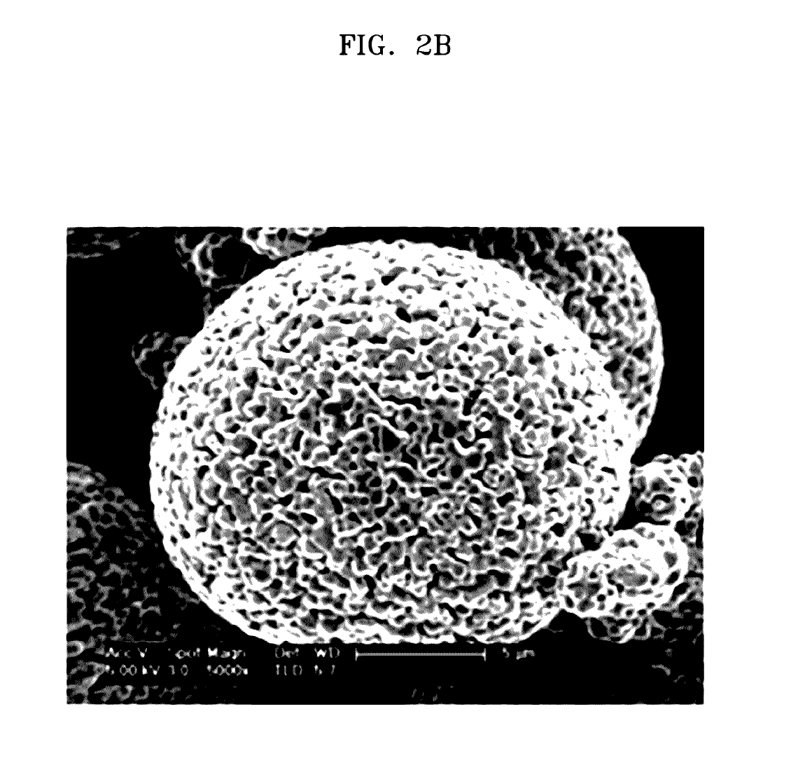

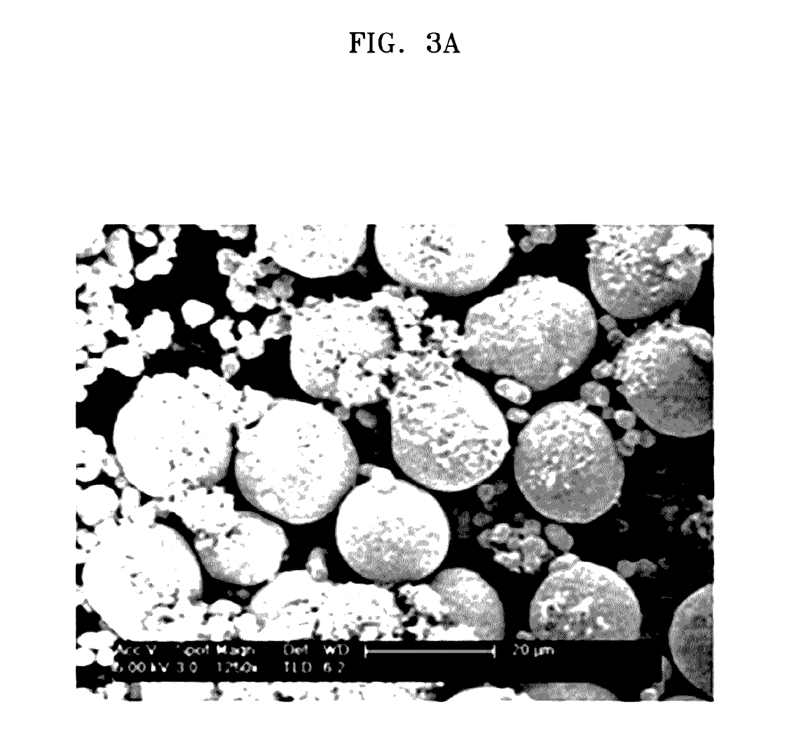

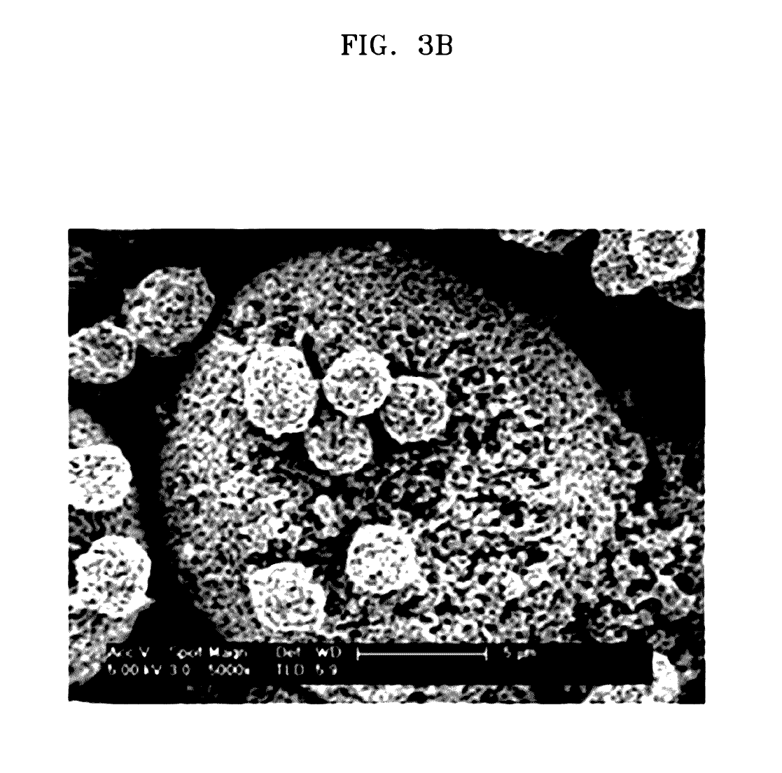

The cobalt oxides of Example 1 and Comparative Example 1 were subjected to SEM analysis, and the results were shown in FIGS. 2A, 2B, 3A, and 3B. FIGS. 2A and 2B illustrate SEM images showing the cobalt oxide of Example 1 at different magnification levels, and FIGS. 3A and 3B illustrate images showing the cobalt oxide of Comparative Example 1 at different magnification levels.

As shown in FIGS. 2A and 2B, the cobalt oxide of Example 1 showed a normal and smooth spherical particle shape maintained without a rupture after performing the first heat treatment. As shown in FIGS. 3A and 3B, the cobalt oxide of Comparative Example 1 showed a spherical particle shape that was ruptured or collapsed after performing the first heat treatment. Accordingly, it may be seen that the cobalt oxide of Comparative Example 1 had difficulty in maintaining a normal spherical particle shape.

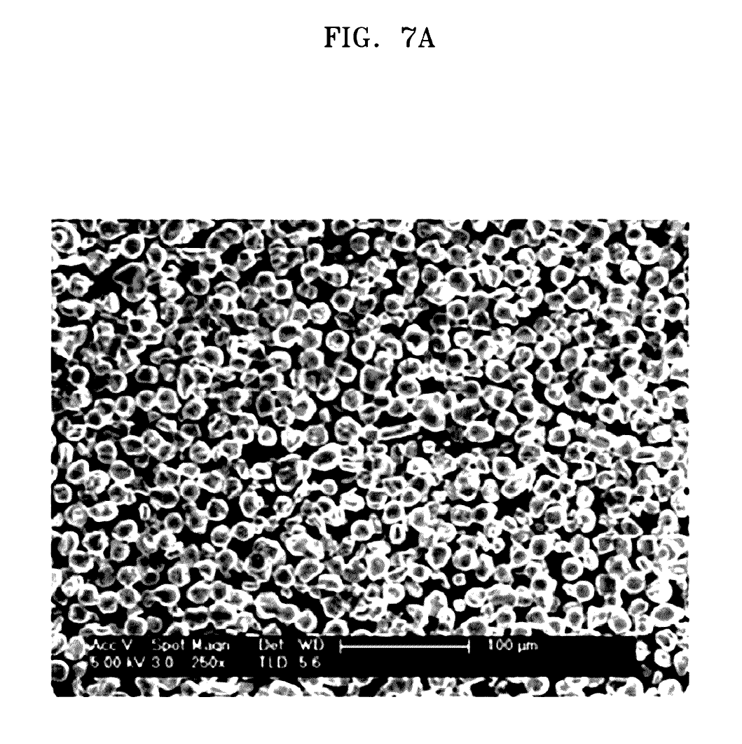

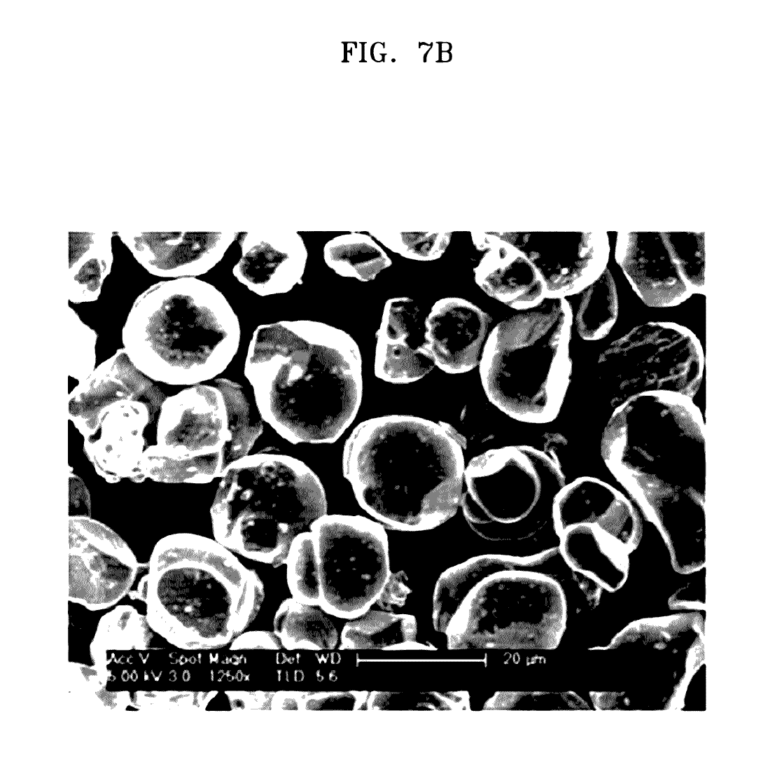

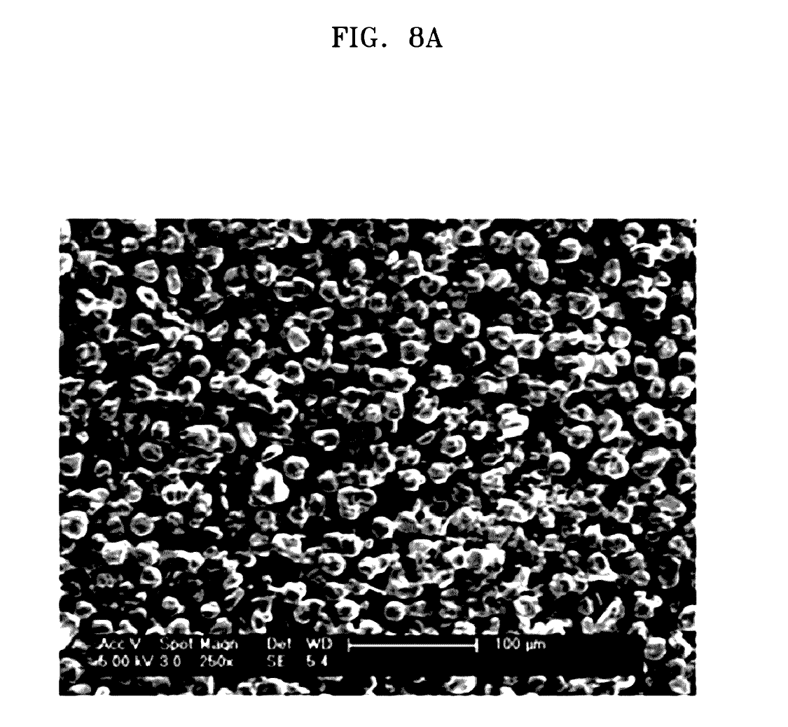

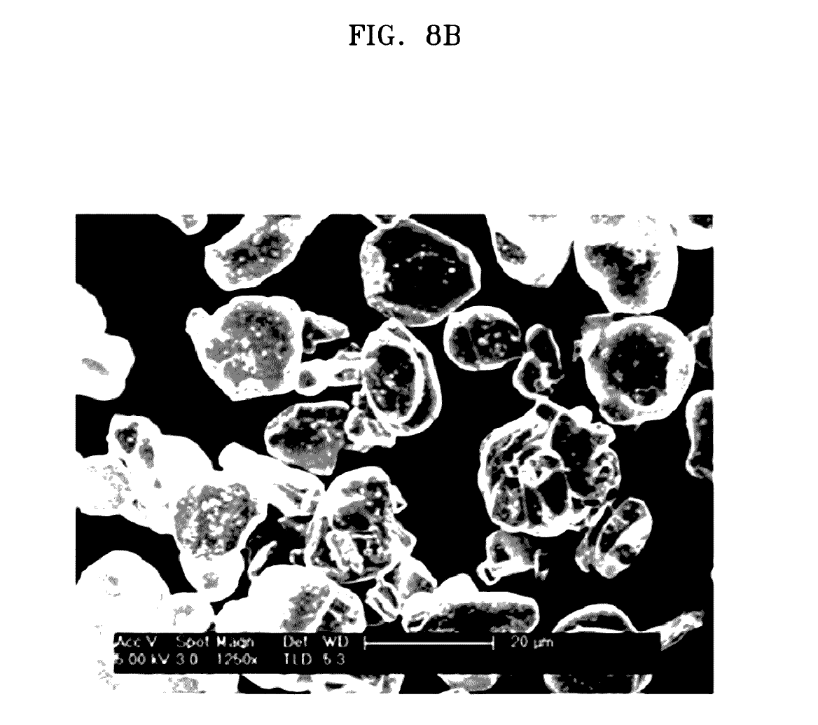

In addition, the lithium cobalt oxides obtained by using the cobalt oxides of Example 1 and Comparative Example 1 were also subjected to the SEM analysis, and the results are shown in FIGS. 7A, 7B, 8A, and 8B.

As shown in FIGS. 8A and 8B, in regard to the lithium cobalt composite oxide prepared by using the cobalt oxide of Comparative Example 1, the cobalt oxide having a low particle strength, it may be seen that a spherical shape of the lithium cobalt composite oxide was ruptured and granules were partially formed in the lithium cobalt composite oxide particles when the cobalt oxide and lithium carbonate were mixed together. Meanwhile, as shown in FIGS. 7A and 7B, in regard to the lithium cobalt composite oxide prepared by using the cobalt oxide of Example 1, the cobalt oxide having a high particle strength, it may be seen that a spherical shape of the lithium cobalt composite oxide was well maintained.

### EVALUATION EXAMPLE 3

### Mixer Test

In manufacturing the lithium cobalt composite oxides according to Example 1 and Comparative Example 1, the cobalt oxide and the lithium carbonate were dry-blended for about 0.5 hours in a mixer, and then, subjected to the analysis using a scanning electron microscope to examine particle strength of the lithium cobalt oxide.

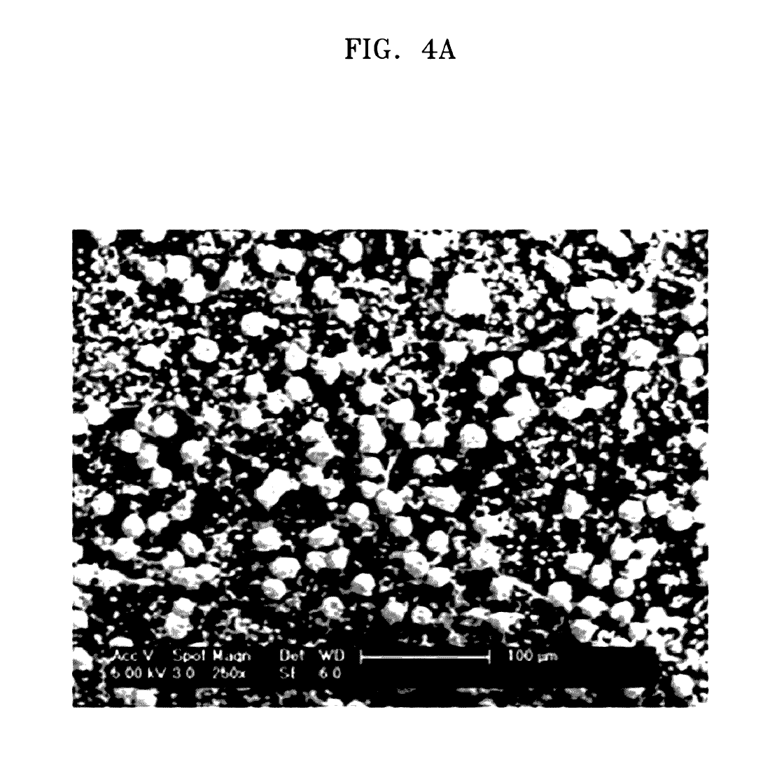

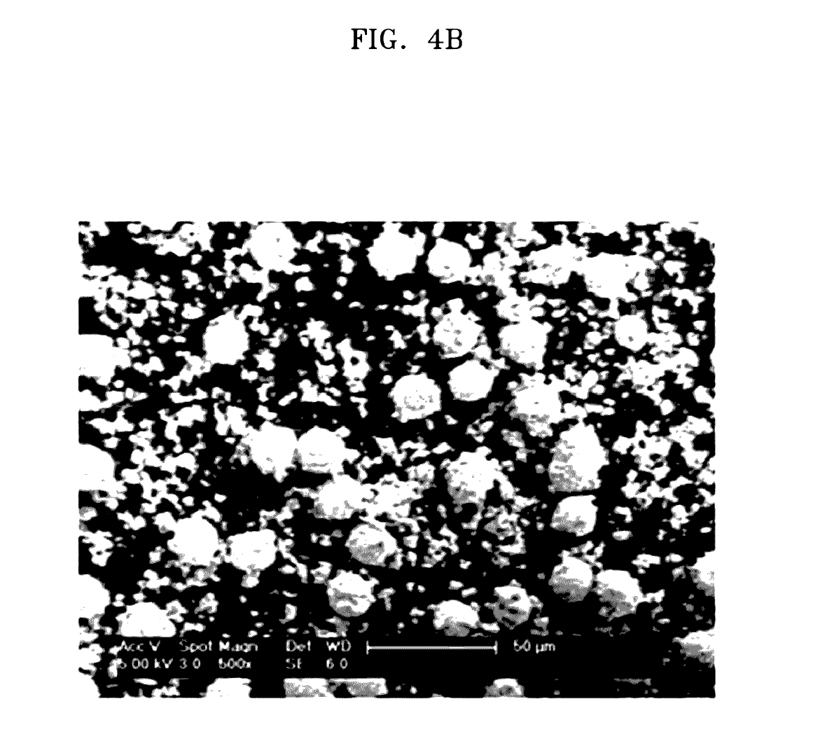

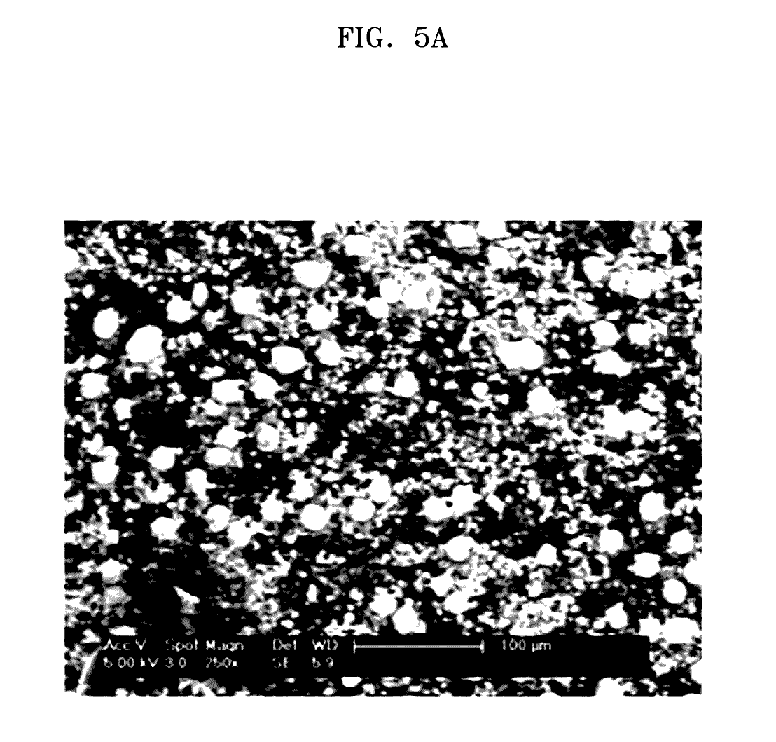

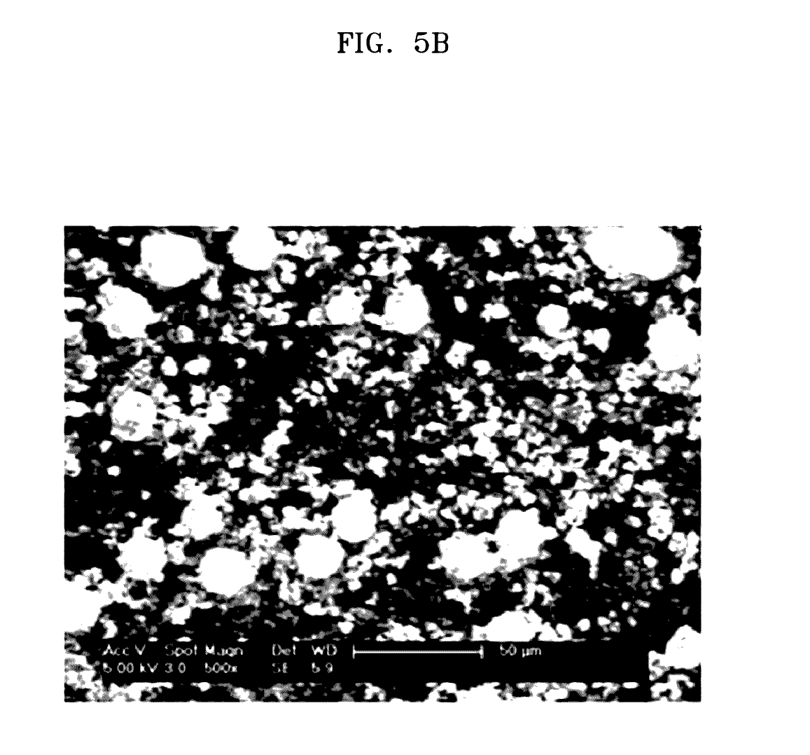

The analysis results are shown in FIGS. 4A, 4B, 5A, and 5B.

As shown in FIGS. 4A, 4B, 5A, and 5B, the spherical particle shape of the cobalt oxide of Example 1 was less ruptured than that of the cobalt oxide of Comparative Example 1 after dry-blending the cobalt oxide and the lithium carbonate. For example, it may be seen that the cobalt oxide of Example 1 had a stronger particle strength than the cobalt oxide of Comparative Example 1.

### EVALUATION EXAMPLE 4

### Particle Size Distribution Test

The cobalt oxides of Example 1 and Comparative Example 1 were subjected to the particle size distribution test.

In the particle size distribution analysis, the particle size of the cobalt oxides was measured by a dynamic light scattering method. To evaluate the measured particle size distribution, the particle diameters D10, D90, and D50, and the difference between the particle diameters D90 and D1 (D90-D10) were calculated based on the volumes of the particles according to dry laser diffractiometry.

The difference between the particle diameters D90 and D10 denotes a value indicating a degree of particle size distribution of powders. The smaller the value, the more uniform and narrower the powders in the particle size distribution.

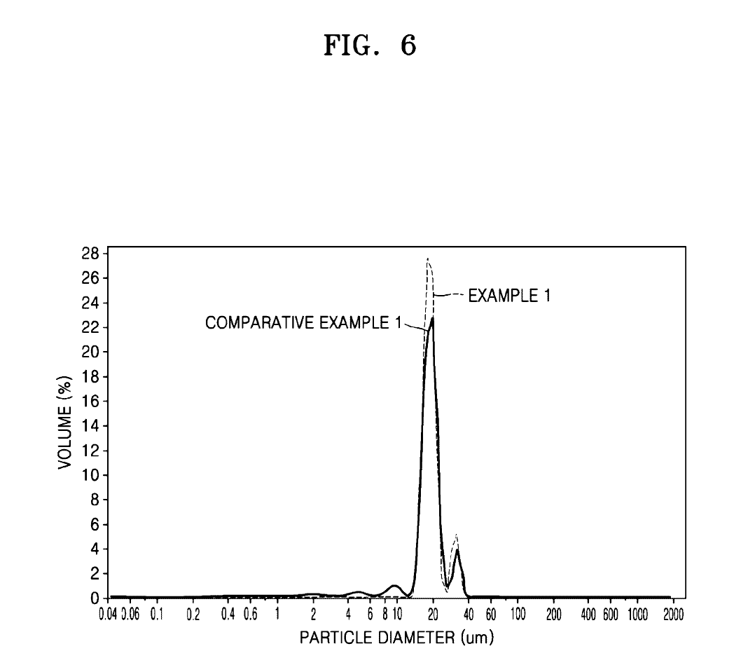

The results of the particle size distribution analysis are shown in FIG. 6 and Table 2.

TABLE 2

| | D10 | D90 | D50 | D90 − D10 |
|---|---|---|---|---|
| Division | (μm) | (μm) | (μm) | (μm) |
| Example 1 | 16.1 | 27.7 | 18.9 | 11.6 |
| Comparative | 5.3 | 24.3 | 18.3 | 19 |
| Example 1 | | | | |

Referring to FIG. 6 and Table 2, it may be seen that the cobalt oxide of Example 1 had more uniform and narrower particle size distribution, compared to that of the cobalt oxide of Comparative Example 1.

However, a peak was observed near fine particles and granules of the cobalt oxide of Comparative Example 1, and in this case, the cobalt oxide of Comparative Example 1 had a smaller particle diameter D10 than that of the cobalt oxide of Example 1. Accordingly, it may be seen that the cobalt oxide of Comparative Example 1 (having a weak particle strength) was easily ruptured by an external stimulus, and accordingly, was pulverized.

### EVALUATION EXAMPLE 5

### Mixture Density and Sphericity

The lithium cobalt oxides of Example 1 and Comparative Example 1 were subjected to measurement of a mixture density and a particle shape thereof, and the results are shown in Table 3. The mixture density was measured by dividing the weight of the electrode components other than the current collector (i.e., active material, conductive material, binder, etc.) by the volume of the electrode.

TABLE 3

| | Mixture density | |
|---|---|---|
| Division | (g/cc) | Particle shape |
| Example 1 | 3.95 | Spherical |
| Comparative Example 1 | 3.78 | Non-spherical |

Referring to Table 3, it may be seen that the lithium cobalt oxide of Example 1 had a large mixture density and a spherical particle shape, which benefit from minimizing a specific surface area of the particles, compared to the lithium cobalt oxide of Comparative Example 1. Thus, the lithium cobalt oxide of Example 1 may provide chemical stability for a positive electrode under conditions of charging and discharging at a high temperature.

### EVALUATION EXAMPLE 6

### Charge and Discharge Experiment

Regarding the coin cells of Manufacture Example 1 and Comparative Manufacture

Example 1, the charge and discharge properties were evaluated by using a charge and discharge regulator (Manufacture: TOYO, Model: TOYO-3100), and the results are shown in Table 4.

In the coin cells of Manufacture Example 1 and Comparative Manufacture Example 1, a formation was performed by charging and discharging each of the coin cells one time at 0.1 C, and then, charging and discharging were performed one time at 0.1 C to verify the initial charging and discharging property. Then, charging and discharging were repeated 240 times at 1 C to investigate cycle properties. The charging procedure was set to be started in a constant current (CC) mode until a voltage of about 4.50V, and then, adjusted to a constant voltage (CV) mode so that the charging would be cut off at 0.01 C. The discharging procedure was set to be cut off in a CC mode at 3.0 V.

The initial charging efficiency in Table 4 was measured according to Equation 1 below.

(1) Charge capacity and discharge capacity

A charge capacity and a discharge capacity were measured in the first cycle.

(2) Initial charge efficiency (I.C.E)

I.C.E was measured according to Equation 1 below.

I.C.E [%]=[1^{st} cycle discharge capacity/1^{st} cycle charge capacity]×100 [Equation 1]

TABLE 4

| | Charge | | |
|---|---|---|---|
| | capacity | Discharge | |
| Division | (mAh/g) | capacity (mAh/g) | I.C.E (%) |
| Manufacture | 208.3 | 202.5 | 97.2 |
| Example 1 | | | |
| Comparative | 203.2 | 196.4 | 96.6 |
| Manufacture | | | |
| Example 1 | | | |

“Also, the charge and discharge property of the coin cell of Manufacture Example 2 was evaluated. As a result, the coin cell of Manufacture Example 2 has the same charge and discharge property as that of the coin cell of Manufacture Example 1.”

### EVALUATION EXAMPLE 7

### High-Efficiency Characteristics

The coin cells of Manufacture Example 1 and Comparative Manufacture Example 1 were charged under conditions associated with a constant current (i.e., 0.1 C) and a constant voltage (i.e., 4.5 V cut off at 0.01 C). After 10 minutes of rest, the coin cells were discharged under conditions associated with a constant current (i.e., 0.1 C, 0.2 C, 0.5 C, or 1 C) until their voltage reached 3.0 V. That is, the charge-discharge cycle were repeated under conditions of discharging at 0.1C, 0.2 C, 0.5 C, or 1 C, thereby evaluating characteristics of each of the coin half cells.

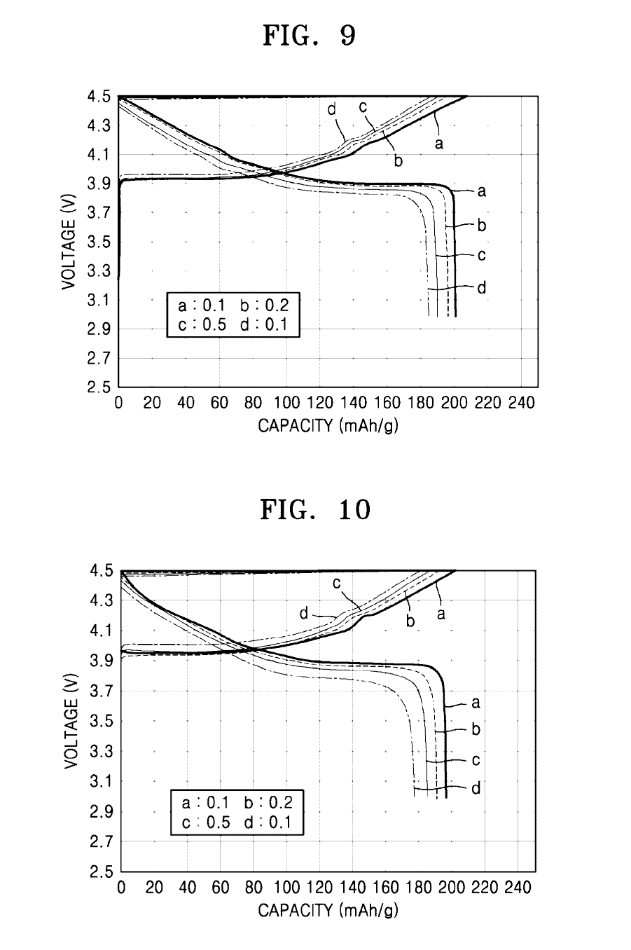

The coin half cells of Manufacture Example 1 and Comparative Manufacture Example 1 were subjected to the measurement of high-efficiency discharge properties, and the results are shown in Table 5 and FIGS. 9 and 10.

The high-efficiency discharge properties in Table 5 were calculated according to Equation 2 below.

High-efficiency discharge property (%)=(Discharge capacity when a cell is discharged at 1 C)/(Discharge capacity when a cell is discharge at 0.1 C)* 100 [Equation 2]

TABLE 5

| | Discharge | | Discharge | High-efficiency |
|---|---|---|---|---|
| | capacity | Discharge | capacity | discharge |
| | @0.2 C | capacity | @1 C | characteristics |
| Division | (mAh/g) | @0.5 C (mAh/g) | (mAh/g) | (%) |
| Manufacture | 196.1 | 189.6 | 184.6 | 91.2 |
| Example 1 | | | | |
| Comparative | 190.2 | 196.4 | 177.2 | 90.2 |
| Manufacture | | | | |
| Example 1 | | | | |

Referring to Table 5 and FIGS. 9 and 10, it may be seen that the coin half cell of

Manufacture Example 1 had improved high-efficiency discharge properties, compared to the coin half cell of Comparative Manufacture Example 1.

By way of summation and review, lithium cobalt oxide may have an excellent energy density per volume and may be used as a positive electrode active material. Controlling particle size and particle shape of lithium cobalt oxide powder may help further improve the capacity of lithium cobalt oxide.

As described above, according to the one or more of the above embodiments, cobalt oxide may have strong particle strength, and thus lithium cobalt oxide having a good sphericity and an improved mixture density may be prepared by using the cobalt oxide. In addition, the lithium cobalt oxide may be used to manufacture a lithium secondary battery having improved charge and discharge characteristics and high-efficiency properties.

The embodiments may provide a cobalt oxide for a lithium secondary battery having improved particle strength.

The embodiments may provide a lithium secondary battery having improved capacity and high-efficiency characteristics, the lithium secondary battery including a positive electrode using the lithium cobalt oxide.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A cobalt oxide for a lithium secondary battery, wherein the cobalt oxide composition:
includes particles having a particle strength of about 25 MPa to about 50 MPa,
has a particle diameter D10 of about 14 μm to about 18 μm, and
has a particle diameter difference between a particle diameter D90 and the average particle diameter D10 of less than about 15 μm.

2. The cobalt oxide as claimed in claim 1, wherein the cobalt oxide composition has an average particle diameter D50 of about 18.4 μm to about 19 μm.

3. The cobalt oxide composition as claimed in claim 1, wherein the cobalt oxide composition has a particle diameter D90 of about 26 μm to about 28 μm.

4. The cobalt oxide as claimed in claim 1, wherein the particle diameter difference between the particle diameter D90 and the particle diameter D10 is about 10 μm to about 12 μm.

5. A lithium cobalt oxide for a lithium secondary battery, wherein:
the lithium cobalt oxide composition has a mixture density in a range of about 3.8 g/cc to about 3.97 g/cc, and
the lithium cobalt oxide includes lithium cobalt oxide represented by Formula 1:
LiₐCo_{b}O_{c} [Formula 1]
wherein, in Formula 1, a, b, and c satisfy the following relations: 0.9≦a≦1.1, 0.98≦b≦1.00, and 1.9≦c≦2.1.

6. The lithium cobalt oxide as claimed in claim 5, wherein the lithium cobalt oxide composition includes lithium cobalt oxide that further includes at least one of magnesium (Mg), calcium (Ca), strontium (Sr), titanium (Ti), zirconium (Zr), boron (B), aluminum (Al), and fluorine (F).

7. The lithium cobalt oxide as claimed in claim 5, wherein an average particle diameter D50 of the lithium cobalt oxide composition is about 5 μm to about 20 μm.

8. A method of preparing the lithium cobalt oxide as claimed in claim 5, the method comprising:
providing a cobalt oxide composition; and
heat treating a mixture of the cobalt oxide composition and a lithium precursor at a temperature in a range of about 900° C. to about 1,100° C.,
wherein the cobalt oxide composition:
includes particles having a particle strength of about 25 MPa to about 50 MPa,
has a particle diameter D10 of about 14 μm to about 18 μm, and
has a particle diameter difference between a particle diameter D90 and the average particle diameter D10 of less than about 15 μm.

9. The method as claimed in claim 8, wherein providing the cobalt oxide composition includes:
preparing cobalt hydroxide by co-precipitating a mixture of a cobalt precursor, a precipitator, and a chelating agent;
drying the cobalt hydroxide; and
heat treating the dried cobalt hydroxide at a temperature of about 800° C. to about 850° C.

10. The method as claimed in claim 9, wherein heat treating the dried cobalt hydroxide is performed under an oxidizing gas atmosphere.

11. The method as claimed in claim 8, wherein heat treating the mixture is performed under an oxidizing gas atmosphere.

12. A lithium secondary battery comprising a positive electrode, the positive electrode including the lithium cobalt oxide as claimed in claim 5.
